(19) United States
(12) Patent Application Publication
(10) Pub. No.: US 2013/0161426 A1
(43) Pub. Date: Jun. 27, 2013

(54) Glass Vial Destructor

(71) Applicants: Richard J. Bottorff, Rochester, MN (US); Chad M. Holznagel, Rochester, MN (US)

(72) Inventors: Richard J. Bottorff, Rochester, MN (US); Chad M. Holznagel, Rochester, MN (US)

(73) Assignee: RBM SUPERIOR SERVICE LLC, Hayfield, MN (US)

(21) Appl. No.: 13/332,671

(22) Filed: Dec. 21, 2011

(51) Int. Cl. B02C 13/30; B02C 25/00

(52) U.S. Cl. 241/36; 241/99

(57) ABSTRACT

A machine for destructing glass medicine vials comprises a housing having a cover with glass vial input tubes mounted thereon such that the tubes pass through a top surface of the cover. Located within the housing is a motor-driven rotor on which is mounted at least one pair of generally circular disks, where the disks have insets formed therein defining a pocket for receiving a portion of a vial therein. The rotor is positioned such that a vial dropped down the vial inlet tube will come to rest on the periphery of the pair of disks with a portion of the vial still disposed in the tube. The vial will ultimately drop into their insets as the rotor turns. A tooth formed in the periphery of the insets fractures the vial and the shards fall through an open bottom of the housing.

### BACKGROUND OF THE INVENTION

I. Field of the Invention

This invention relates generally to hospital and medical waste disposal devices and more particularly to an apparatus for crushing used frangible glass drug vials to prevent unauthorized access to narcotic drugs.

II. Discussion of the Prior Art

In hospitals and other medical facilities, liquid drugs to be injected into a patient by the nursing staff are usually contained in a glass vial or ampoule having a self-sealing elastomeric cap that allows a needle of a hypodermic syringe to penetrate upon filling the syringe from the vial. Oftentimes, the vial will contain a surplus of the drug over and above the dosage prescribed by the physician. This has presented a disposal problem. Partially empty drug vials of narcotics, such as morphine, were simply tossed into a wastebasket. Hospital maintenance personnel would sometimes retrieve the vials for either illegal self-administration of the drug or for sale on the street.

A need therefore exists for a way of preventing unauthorized access and use of liquid, pain killing drugs, such as opiates, commonly used in medical settings. The present invention fulfills such a need.

In particular, the device of the present invention is designed to accept drug vials or ampoules which may be partially filled with a liquid medicament and will crush and deposit the glass shards and liquid contents into a waste container. The mixture of the drug with pulverized glass particles deters any attempts to salvage the drug from the waste container.

It is intended that the device of the present invention be used in patient rooms and, therefore, it is important that the device work noiselessly. Making a device that will crush glass vials in a noiseless manner has proven to be a challenge.

It is therefore an object of the present invention to provide an easy-to-use, silently operating apparatus for shattering glass drug vials and ampoules and for depositing the glass and any remaining liquid contents into a trash receptacle, such as a wastebasket.

### SUMMARY OF THE INVENTION

The foregoing object is attained by providing a housing of a generally rectangular cross-section having a top wall and four mutually perpendicular side walls defining an open bottom, At least one glass vial input tube penetrates through the top wall to the interior of the housing. Disposed within the housing is a motor-driven rotor on which is located at least one pair of generally circular disks that are located in vertical alignment with the lower output end of the vial input tube, The pair of disks on the rotor each includes an inset having a tooth defined at a peripheral location on the disks. The spacing between the lower end of the vial input tube and the pair of rotor disks is such that a lower portion of the vial will reside in the inset of the rotor while the upper portion of the vial remains within a lower end of the vial input tube. Now, as the rotor is slowly driven, the teeth on the disk pair break through and shatter the frangible glass vial with the shards dropping through the open bottom of the housing into a waste container.

### DESCRIPTION OF THE DRAWINGS

The foregoing features, objects and advantages of the invention will become apparent to those skilled in the art from the following detailed description of the preferred embodiment, especially when considered in conjunction with the accompanying drawings in which like numerals in the several views refer to corresponding parts.

FIG. 1 is an isometric view of a preferred embodiment of the present invention; and

FIG. 2 is an exploded view of the preferred embodiment.

### DETAILED DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

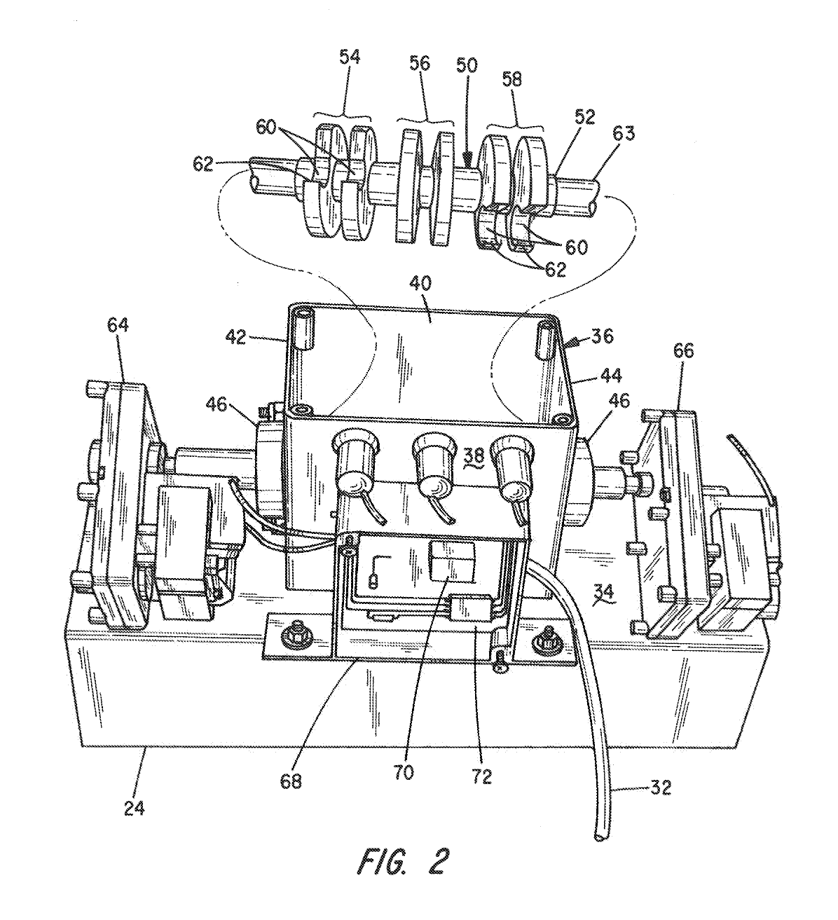

Referring to FIG. I, the vial destructor is indicated generally by numeral 10 and is seen to comprise a shoebox-like housing having a cover 12 with a top surface 14 and four mutually perpendicular sides, including a front surface 16, a rear surface 18, a left-end surface 20 and a right-end surface 22. The cover 12 fits over a base 24 which is also rectangular in shape and which is better viewed in the exploded view of FIG. 2.

Projecting through the top surface 14 of the cover 12 are vial inlet tubes 26, each of differing internal diameter and adapted to receive a glass drug vial therethrough. Being of different internal diameter, the vial inlet tubes 26 can accommodate vials having differing outside diameters. The upper ends of the tubes 26 are capped with polyurethane caps 27 that have a slit to form a self-sealing opening through which a vial may be inserted.

The cover's top surface 14 may also have mounted thereon an electrical toggle switch as at 28, and an indicator light 30 for indicating the on/off status of the vial destructor 10. Being electrically operated, there is seen a power cord 32 that is adapted to be connected to a 120 volt, 60 cycle outlet.

Turning next to the exploded view of FIG. 2, base 24 is also seen to comprise a top surface 34 and four mutually perpendicular side walls extending downward and defining an open bottom. Affixed to the top surface 34 and centrally located thereon is an aluminum tube 36 of rectangular cross-section with a front wall 38, a rear wall 40, a left-side wall 42 and a right side wall 44. Disposed at the four corners thereof are bosses 39 having drilled and tapped bores therein.

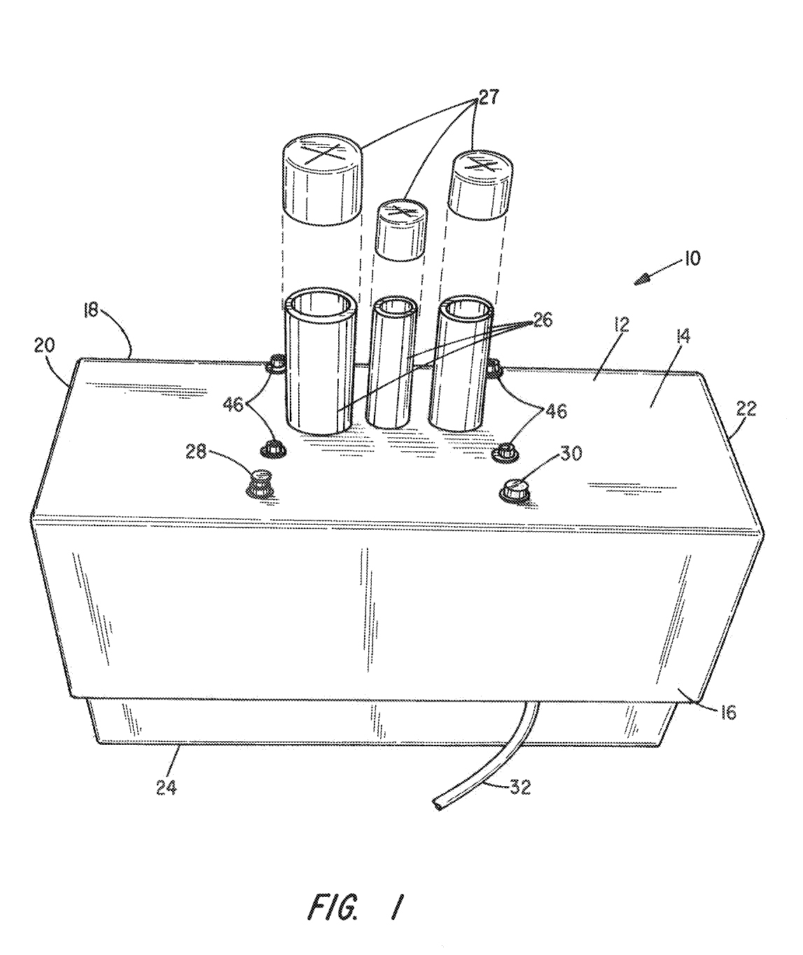

It can be appreciated that when the cover 12 is placed over the base 24 and held in place by the screws, as at 46 in FIG. 1 that enter the tapped bores 39, the interior of the housing assembly is effectively partitioned into three compartments with the walls 42 and 44 of the tube 36 defining the partitioning walls. Mounted on the partitioning walls 42 and 44 are bearings 46 for journaling the shaft 48 of a rotor 50.

With continued reference to FIG. 2, and especially to the make-up of rotor 50, it is seen to comprise an elongated tubular sleeve 52 on which are concentrically mounted a plurality of disk pairs 54, 56 and 58. Each of the disks includes a somewhat J-shaped inset as at 60 having an edge defining a tooth member 62 at the peripheral surface of the disk in which the inset is formed. Extending through the sleeve 52 is a solid cylindrical shaft 63, the ends of which project beyond the ends of the sleeve 52. A bore of a non-circular profile (not shown) extends inward from each of the opposed ends of the shaft 63 for accommodating entry of a complimentary shaped gear motor shaft therein. The shaft 63 is journaled for rotation in the bearings 46 such that the rotor disk pairs 54, 56 and 58 overlay an opening (not shown) in the top surface 34 of the base 24.

While it would be possible to drive the rotor assembly with a single gear motor, it has been found expedient for noise-limiting purposes to employ two smaller gear motors for driving the rotor. As seen in FIG. 2, a first gear motor 64 is positioned on the top surface 34 to the left of the housing wall 42 and a second gear motor 66 is positioned to the right of the partition wall 44. The gearbox transmissions are configured such that when their motors are energized, both will turn the rotor in the same direction. Without limitation, the gear motors 64 and 66 may comprise a Model 1NGG8 available through the W.W. Grainger Company of Lake Forest, Ill. The gear motor output shafts of that model rotate at 2 RPM and operates from a 115 volt AC source. It has been found that this gear motor drive mechanism operates extremely quietly.

Contained within an outlet box 68 mounted to the top surface 34 of the base 24 is a relay 70 for switching the 115 volt source to the inputs of the gear motors. The actuation of the relay in the preferred embodiment being described is controlled by a solid state Arduino controller. It incorporates a microcontroller on the board that is programmed using the Arduino programming language. However, limitation to this particular controller is not intended. In one embodiment, the control board may receive an input signal, from a manually operated toggle switch shown at 28 in FIG. 1. The controller is programmed so that upon receipt of the input signal, the gear motors will be made to run for a predetermined time, say for two minutes, and then will automatically shut off.

In another embodiment, instead of receiving a control signal from a pushbutton switch, it is also contemplated that the machine will be triggered on upon detection of a glass vial being dropped down the vial input tubes 26. For that purpose, optical sensors, as at 72 may be positioned to detect the presence of a vial dropping out beyond the lower end of the vial input tubes onto the rotor 50.

It should be further understood that the disk pairs 54, 56 and 58 of the rotor are vertically aligned with the vial input tubes 26 when the cover 12 is mounted on and secured to the base unit 24 such that an inserted vial will land on one of the disk pairs.

In operation, a nurse administering an injection in a patient will first fill a hypodermic syringe with a quantity of the medicament prescribed by a physician in his order. This is generally accomplished by pushing the syringe's hypodermic needle through a self-sealing stopper in a glass vial containing the medicament. After the syringe is loaded, the nurse will drop the vial, which may still contain a quantity of the medicament, down an appropriately sized one of the vial inlet tubes 26 of the machine 10. The vial will come to rest on the peripheral surface of an associated disk pair 54, 56 or 58 with an upper portion of the vial still resident in the lower end of the associated vial input tube.

Assuming that the machine 10 is equipped with optical vial sensors, the sensor associated with the selected tube will detect the presence of a vial and will send a control signal to the controller board causing the relay 70 to close its contacts so as to complete a circuit from an AC source to the gear motors 64 and 66, turning them on to rotate the rotor 50. As the rotor turns, a point will be reached where the vial will drop into one of the pair of insets 60 on that disk and as the rotor continues to turn, the peripheral tooth 62 on that inset will shatter the vial. The controller is preferably programmed to cause the rotor to slowly and quietly rotate until the glass splinters fall by gravity through the opening in the base top surface 34 located below the rotor and into a waste receptacle on which the machine of the present invention is situated. Because the gear motors 64 and 66 turn the rotor at a slow rate of only, say, 2 RPM, the machine is very silent in its operation, which was an important target in producing a marketable device intended for use in a hospital room setting.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. Apparatus for crushing frangible glass vials comprising:
(a) a housing having a top wall and four mutually perpendicular side walls and an open bottom;
(b) at least one vial input tube extending through the top wall to an interior of the housing; and
(c) a motor driven rotor journaled for rotation within the housing, the rotor having a pair of disks concentrically mounted thereon, each of the pair of disks including at least one inset defining a tooth edge on a peripheral surface of said disks, the inset adapted to capture a first portion of a glass vial dropped through the vial input tube with a remaining portion of the glass vial remaining residing in the vial input tube whereby the tooth edges fracture the glass vial as the rotor is driven and with the crushed glass exiting the housing through the open bottom.

2. The apparatus as in claim 1 and further including at least one motor disposed in the housing for driving the rotor.

3. The apparatus as in claim 1 and further including a pair of motors disposed in the housing for driving the rotor.

4. The apparatus in claim 3 wherein the housing further includes a pair of parallel, spaced-apart partition walls extending between front and rear ones of the four mutually perpendicular side walls, the parallel, spaced-apart partition walls supporting bearings for the journaling the rotor.

5. The apparatus as in claim 4 wherein a first of the pair of motors is disposed in the housing between one of the partition walls and a right end one of the four mutually-perpendicular side walls and the other of the pair of motors is disposed between the other of the partition walls and a left end one of the four mutually-perpendicular side walls.

6. The apparatus as in claim 2 and further including a control circuit responsive to an input signal for energizing the motor for a preset time interval.

7. The apparatus as in claim 6 wherein said input signal originates at a manually operated switch.

8. The apparatus as in claim 6 and further including a sensor disposed in the vial input tube for sensing the presence of a glass vial therein and producing the input signal.

9. The apparatus of claim 3 wherein the motor driven rotor comprises a solid, cylindrical core member contained within a tubular sleeve and the pair of disks are welded concentrically onto the tubular sleeve, with opposed ends of the cylindrical core member extending outward beyond opposed ends of the tubular sleeve and the opposed ends of the core member having a non-circular bore formed inward thereof adapted to receive a complimentary shaped drive shaft of the pair of motors.

10. Apparatus for crushing frangible glass vials, comprising:
(a) a housing having a top wall, four mutually perpendicular side walls and an open bottom;
(b) a plurality of vial input tubes extending through the top wall to an interior of the housing;
(c) a motor driven rotor journaled for rotation within the housing, the rotor having a pair of disks associated with each of vial input tubes, concentrically mounted thereon, each of the pairs of disks including at least one inset defining a tooth edge at a peripheral surface of said disks, the plurality of the pairs of disks being positioned relative to the vial input tubes such that the insets of the pairs of disks are adapted to capture a first portion of a glass vial dropped through an associated vial input tube with a remaining portion of the glass vial residing in the associated vial input tube, whereby the tooth edges fracture the glass vial as the rotor is driven and with the crushed glass exiting the housing through the open bottom.

11. The apparatus as in claim 10 and further including at least one motor disposed in the housing for driving the rotor.

12. The apparatus as in claim 10 and further including a pair of motors disposed in the housing for driving the rotor.

13. The apparatus in claim 12 wherein the housing further includes a pair of parallel, spaced-apart partition walls extending between front and rear ones of the four mutually perpendicular side walls, the parallel, spaced-apart partition walls supporting bearings for the journaling the rotor.

14. The apparatus as in claim 13 wherein a first of the pair of motors is disposed in the housing between one of the partition walls and a right end one of the four mutually-perpendicular side walls and the other of the pair of motors is disposed between the other of the partition walls and a left end one of the four mutually-perpendicular side walls.

15. (canceled)

16. The apparatus as in claim 12 and further including a control circuit responsive to an input signal for energizing the motor for a predetermined time interval.

17. The apparatus as in claim 15 wherein said input signal originates at a manually operated switch.

18. The apparatus as in claim 15 and further including a sensor disposed in the vial input tube for sensing the presence of a glass vial therein and producing the input signal.

19. The apparatus as in claim 10 wherein the plurality of vial input tubes are of a differing internal diameter.

20. The apparatus as in claim 19 and further including an elastomeric cap having a self-closing slit as a cover on an upper end of the vial input tubes.

21. The apparatus of claim 12 wherein the motor driven rotor comprises a solid, cylindrical core member contained within a tubular sleeve and the pair of disks are welded concentrically onto the tubular sleeve, with opposed ends of the cylindrical core member extending outward beyond opposed ends of the tubular sleeve and the opposed ends of the core member having a non-circular bore formed inward thereof adapted to receive a complimentary shaped drive shaft of the pair of motors.
